(19) United States
(12) Patent Application Publication
(10) Pub. No.: US 2020/0386552 A1
(43) Pub. Date: Dec. 10, 2020

(54) PRIMARY NAVIGATION SYSTEM FOR TUGBOATS WITH AN OBSTRUCTED PILOT VIEW

(71) Applicant: Bechtel Oil, Gas & Chemicals, Inc., Houston, TX (US)

(72) Inventor: James Nickols Crow, Friendswood, TX (US)

(73) Assignee: Bechtel Oil, Gas & Chemicals, Inc., Houston, TX (US)

(21) Appl. No.: 16/628,897

(22) PCT Filed: Jul. 18, 2017
(86) PCT No.: PCT/US17/42632

§ 371 Date: Jan. 6, 2020

(51) Int. Cl. G01C 21/20; G01S 17/93; G01S 17/86; B63B 35/66; B63B 49/00; H04R 1/04; H04R 1/08; H04N 5/225; H04N 7/18; G10L 25/51; G06T 7/70; H04N 5/247; G06K 9/00

(52) U.S. Cl. CPC G01C 21/203; G06T 2207/30252; G01S 17/86; B63B 35/66; B63B 49/00; H04R 1/04; H04R 1/08; H04N 5/2253; H04N 5/2252; H04N 7/181; G10L 25/51; G06T 7/70; H04N 5/247; G06K 9/00624; H04R 2499/13; G01S 17/93

(57) ABSTRACT

A primary navigation system for a tugboat that is detachably connected to another vessel, which obstructs the tugboat's pilot view when assisting the vessel.

### FIELD OF THE DISCLOSURE

The present disclosure generally relates to a primary navigation system for tugboats, also referred to herein as tugs, with an obstructed pilot view. More particularly, the present disclosure relates to a primary navigation system for a tugboat that is coupled to another vessel, which obstructs the tugboat's pilot view when assisting the vessel.

### BACKGROUND

Tugboats may be used in offshore waters or inland waters depending on their design. Tugboats are used to maneuver large ships in harbors and bays. Tugboats may also be used to maneuver one or more connected barges through inland waters. A tugboat can assist such vessels by towing astern (pulling), pushing ahead or towing alongside. Each method has advantages and disadvantages. When navigating through inland waters, pushing ahead is often preferred over the other methods because it is faster and easier to maneuver the vessel in front due to the shorter tow-lines, also referred to as the bridle, that are required. In other words, inland waters restrict maneuverability making shorter tow lines necessary for safe and efficient maneuvering of the vessel.

Pushing ahead however, has its disadvantages. For example, large ships and barges with large cargo may obstruct the tug pilot's view when pushing ahead. Rule 5 of the US Coast Guard Navigation Rules requires all vessels to maintain a proper look-out by sight and hearing, as well as by all available means appropriate in the prevailing circumstances and conditions, so as to make a full appraisal of the situation and of the risk of collision. Thus, another assist or lead tugboat is required to assist the tugboat pushing ahead when its pilot view is obstructed. The assist tug is typically positioned alongside the vessel on either side to provide the proper look-out. Besides the additional cost of an assist tug, more room is required to navigate in-land waterways.

### BRIEF DESCRIPTION OF THE DRAWINGS

The present disclosure is described with reference to the accompanying drawings, in which like elements are referenced with like reference numbers, and in which:

FIG. 1 is a schematic diagram illustrating a primary navigation system for a tugboat according to the present disclosure.

FIG. 2A is a front elevational view illustrating one embodiment of a navigation detection assembly for the primary navigation system.

FIG. 2B is a top view of the navigation detection assembly illustrated in FIG. 2A.

FIG. 3 is a schematic diagram illustrating an exemplary pilot view from the wheelhouse of a tugboat during a blind push of a barge carrying cargo.

FIG. 4 is a schematic diagram illustrating an exemplary pilot view from the wheelhouse of a tugboat during a blind push of a barge carrying cargo using the primary navigation system in FIG. 1.

### DETAILED DESCRIPTION OF THE PREFERRED EMBODIMENTS

The present disclosure overcomes one or more of the prior art disadvantages with a primary navigation system for a tugboat that is coupled to another vessel, which obstructs the tugboat's pilot view when assisting the vessel. The primary navigation system eliminates the need for an additional assist tugboat.

In one embodiment the present disclosure includes a primary navigation system for a tugboat coupled to a vessel, which comprises: i) a navigation detection assembly detachably connected to a bow of the vessel, the navigation detection assembly including a video camera and a microphone; and ii) a navigation monitoring assembly positioned on the tugboat and coupled with the navigation detection assembly, the navigation monitoring assembly including a video display for images captured by the video camera and a speaker for sounds captured by the microphone.

In another embodiment, the present disclosure includes a method for pushing a vessel away from an object using a tugboat, which comprises: i) detecting the object ahead of the vessel using a navigation detection assembly detachably connected to a bow of the vessel; ii) transmitting real-time images of the object and real-time sound from the navigation detection assembly to the tugboat; and iii) pushing the vessel using at least one of the real-time images of the object and the real-time sound to navigate the tugboat and the vessel away from the object.

The subject matter of the present disclosure is described with specificity, however, the description itself is not intended to limit the scope of the disclosure. The subject matter thus, might also be embodied in other ways, to include different structures, steps and/or combinations similar to and/or fewer than those described herein, in conjunction with other present or future technologies. Moreover, although the term “step” may be used herein to describe different elements of methods employed, the term should not be interpreted as implying any particular order among or between various steps herein disclosed unless otherwise expressly limited by the description to a particular order.

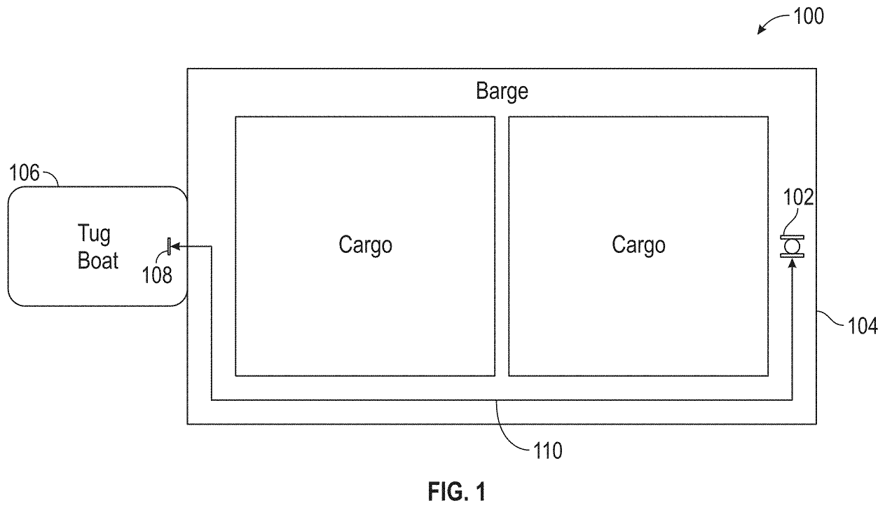

Referring now to FIG. 1, a schematic diagram illustrates a primary navigation system 100 for a tugboat according to the present disclosure. The navigation system 100 includes a navigation detection assembly 102 that may be detachably connected to the bow of a barge 104 or any other vessel. The navigation detection assembly 102 thus, may be disconnected from the barge 104 and connected to the bow of another vessel needing assistance. The navigation system 100 also includes a navigation monitoring assembly 108 that is coupled with the navigation detection assembly 102 and positioned on the tugboat 106. Preferably, the navigation monitoring assembly 108 is portable within at least the wheelhouse of the tugboat 106. The bow of the tugboat 106 is coupled to the stem of the barge 104 by a bridle (not shown), or any other conventional means, for pushing the barge 104 ahead of the tugboat 106. Because pushing ahead is the preferred means of assisting a large vessel or barge with cargo that obstructs the pilot's view in the wheelhouse of a tugboat, the navigation system 100 enables objects, such as a shoreline, a pier or another vessel, to be detected ahead of the vessel regardless of weather conditions. The navigation system 100 thus, enables a tugboat pilot to navigate away from such objects in its path without the need for another assist tug to provide the proper look-out.

The navigation system 100 may further include a cable system 110 that couples the navigation detection assembly 102 and the navigation monitoring assembly 108. The cable system 110 may include a power cable, an ethernet cable, a coaxial cable, a USB cable, and a microphone cable. The power cable transmits power from a power source on the tugboat 106 to the navigation detection assembly 102 and navigation monitoring assembly 108. The coaxial cable transmits real-time images of objects from the navigation detection assembly 102 to the navigation monitoring assembly 108. The ethernet cable transmits signals from the navigation monitoring assembly 108 to the navigation detection assembly 102. The USB cable transmits range finding distance data from the navigation detection assembly 102 to the navigation monitoring assembly 108. The microphone cable transmits real-time sound from the navigation detection assembly 102 to the navigation monitoring assembly 108. The cable system 110 may be quickly and efficiently adjusted (lengthened or shortened) as needed for connecting the navigation detection assembly 102 to the bow of different size vessels and as needed during a push to leave enough slack in the cable system 110 between the barge 104 and the tugboat 106. The cable system 110 is adjustable using well-known techniques and may be connected to the navigation detection assembly 102 and the navigation monitoring assembly by means well-known in the art. Alternatively, the navigation detection assembly 102 may be powered locally by the barge 104 and real-time images of objects and real-time sound from the navigation detection assembly 102 may be transmitted to the navigation monitoring assembly 108 over a wireless network. Similarly, the navigation detection assembly 102 may be wirelessly controlled by the navigation monitoring assembly 108.

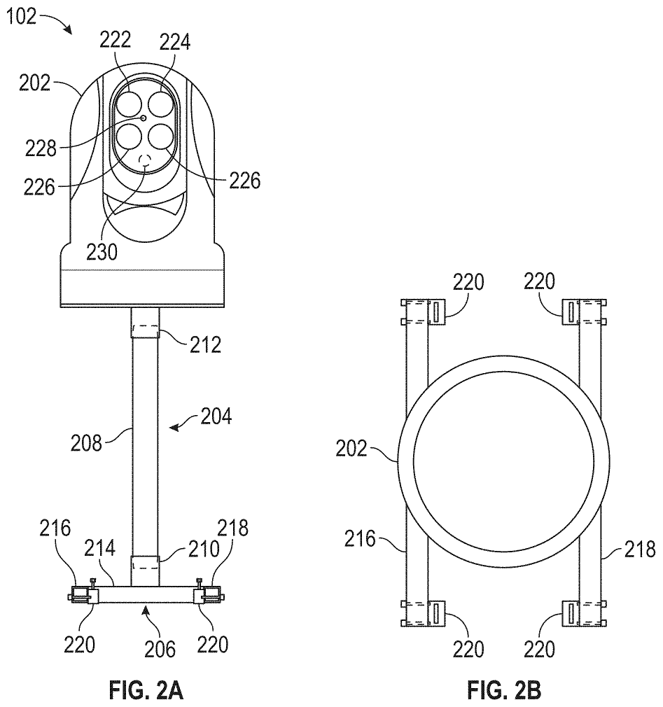

Referring now to FIGS. 2A-2B, one embodiment of the navigation detection assembly 102 is illustrated in a front elevational view (FIG. 2A) and a top view (FIG. 2B). The navigation detection assembly 102 includes a pan/tilt housing 202, an adjustable stand 204 and a base 206. The housing may be made of any weather resistant material (e.g. aluminum or heavy-duty plastic) and is preferably cylindrical in shape and rounded on top to maximize its wind resistance. The adjustable stand 204 preferably includes an interchangeable support 208 that is threadedly coupled at each end to a respective coupler 210, 212. The support 208 and each coupler 210, 212 are preferably made from 2 inch aluminum pipe, however, may be square, larger, smaller or made from different materials provided that the support 208 is interchangeable with other pipe lengths to adjust a height of the housing 202 for an unobstructed view ahead of the vessel. One coupler 210 is connected to the base 206 and the other coupler is connected to the housing 202. These connections are preferably welded connections, however, may be any other type that will withstand most environmental conditions. The base 206 preferably includes a cross support 214 connecting two stabilizing members 216, 218. These connections are preferably welded connections, however, may be any other type that will withstand most environmental conditions. The cross support 214 and two stabilizing members 216, 218 are preferably made from aluminum square tubing, however, may be made from different materials. Each stabilizing member 216, 218 is preferably about twice as long as the cross support 214. Each end of a respective stabilizing member 216, 218 includes a conventional magnetic switch for detachably connecting the navigation detection assembly 102 to the metal bow of a barge or any other vessel. Alternatively, other well-known detachable means may be used to connect the navigation detection assembly 102 to the bow of a barge or any other vessel needing assistance.

The housing 202 includes an integrated high definition, low-light light capable video camera 222 and a thermal imaging video camera 224. The housing further includes an integrated laser range finder 226, a laser calibrator 228 and a high definition microphone 230. Alternatively, the high definition video camera 222, the thermal imaging video camera 224, the laser range finder 226, the laser calibrator 228 and the high definition microphone 230 may be positioned differently in the navigation detection assembly 102 instead of integrated in the housing 202. The navigation monitoring assembly 108 in FIG. 1 may include an integrated touch-screen video display for displaying a distance to objects captured by the laser range finder 226 ahead of the vessel and images captured by the high definition video camera 222 and the thermal imaging video camera 224, a speaker for sounds captured by the microphone 230 and a console for controlling the high definition video camera 222, the thermal imaging video camera 224, the laser range finder 226, the laser calibrator 228 and the high definition microphone 230. Alternatively, the video display, speaker and console may be separated in the navigation monitoring assembly 108 instead of being integrated. The power cable transmits power from a power source on the tugboat 106 to the housing 202, the high definition video camera 222, the thermal imaging video camera 224, the laser range finder 226, the laser calibrator 228, the high definition microphone 230, the video display, the speaker and the console. The coaxial cable transmits real-time images of objects from the high definition video camera 222 and a thermal imaging video camera 224 to the video display. The ethernet cable transmits signals between the console and the navigation detection assembly 102 for controlling the on/off function of each component in the housing 202, the various modes of the high definition video camera 222, the thermal imaging video camera 224, the laser range finder 226, and the laser calibrator 228, and the pan/tilt of the housing. The console may also be used to control the speaker volume and the video display. The microphone cable transmits real-time sound from the navigation detection assembly 102 to the navigation monitoring assembly 108. The USB cable may be used to couple the console with the laser range finder 226 and the laser calibrator 228.

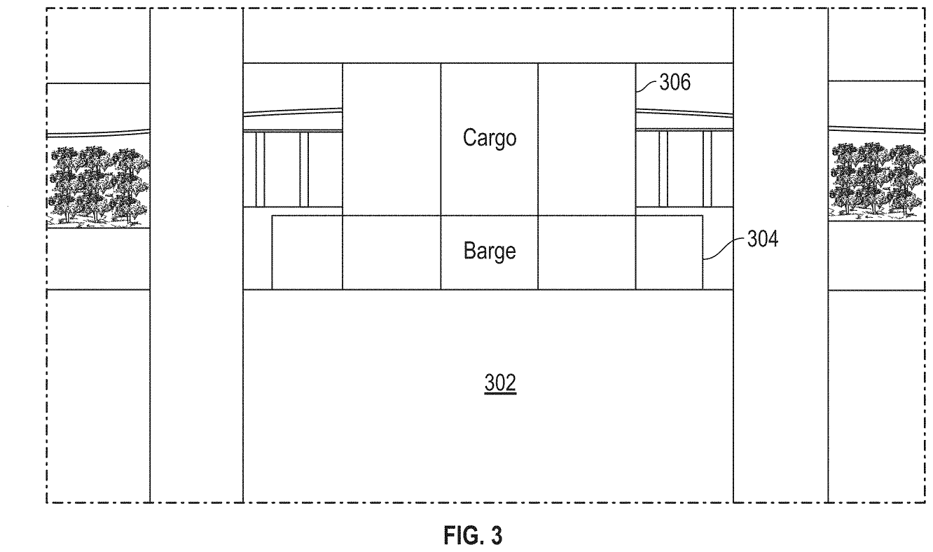

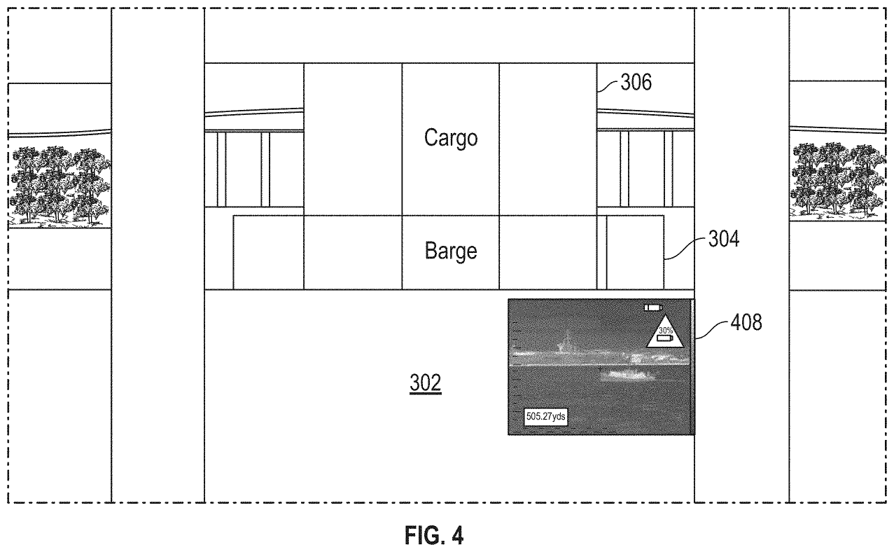

Referring now to FIG. 3, a schematic diagram illustrates an exemplary pilot view from the wheelhouse of a tugboat 302 during a blind push of a barge 304 carrying cargo 306. As demonstrated by FIG. 3, the pilot's view ahead of the barge 304 is clearly obstructed by the cargo 306. In other situations, the pilot's view may be obstructed by a larger vessel the tugboat 302 is assisting by pushing ahead. In either case, the tugboat 302 requires another assist tug to provide the proper look-out for objects such as the shoreline, a pier or another vessel. In FIG. 4, a schematic diagram illustrates an exemplary pilot view from the wheelhouse of the tugboat 302 during a blind push of a barge 304 carrying cargo 306 using the primary navigation system 100 in FIG. 1. As demonstrated by FIG. 4, the pilot's view ahead of the barge 304 is clearly obstructed by the cargo 306. However, the video display 408 for the navigation monitoring assembly 108 includes real-time images captured by the high definition video camera 222 and/or the thermal imaging video camera 224 from the navigation detection assembly 102 detachably connected to the bow of the barge 304 and a distance (505.27 yards) to another vessel detected ahead of the barge 304 by the laser range finder 226. The tugboat 302 and barge 304 may be navigated away from the vessel detected ahead of the barge 304 using only the tugboat 302 and at least one of the real-time images captured by the high definition video camera 222 and/or the thermal imaging video camera 224, the distance to the vessel detected ahead of the barge 304 by the laser range finder 226, and real-time sound captured by the microphone 230. The navigation system 100 in FIG. 1 thus, enables the tugboat pilot to navigate away from such objects in its path without the need for another assist tug to provide the proper look-out. The navigation system 100 is particularly useful for navigation during inclement weather, such as fog, and at night.

While the present disclosure has been described in connection with presently preferred embodiments, it will be understood by those skilled in the art that it is not intended to limit the disclosure to those embodiments. It is therefore, contemplated that various alternative embodiments and modifications may be made to the disclosed embodiments without departing from the spirit and scope of the disclosure defined by the appended claims and equivalents thereof.

1. A primary navigation system for a tugboat coupled to a vessel, which comprises:
a navigation detection assembly detachably connected to a bow of the vessel, the navigation detection assembly including a video camera and a microphone;
a navigation monitoring assembly positioned on the tugboat and coupled with the navigation detection assembly, the navigation monitoring assembly including a video display for images captured by the video camera and a speaker for sounds captured by the microphone; and
an adjustable cable system that couples the navigation detection assembly and the navigation monitoring assembly.

2. (canceled)

3. The navigation system of claim 1, wherein the video camera and the microphone are integrated in a housing for the navigation detection assembly and the video display and the speaker are integrated in a console for the navigation monitoring assembly.

4. The navigation system of claim 1, wherein the navigation detection assembly is detachably connected to the bow of the vessel using a magnetic switch.

5. The navigation system of claim 1, further comprising another video camera, wherein the another video camera includes thermal imaging.

6. The navigation system of claim 1, wherein the navigation detection assembly includes a laser range finder and a laser calibrator.

7. The navigation system of claim 1, wherein the cable system includes a power cable, an ethernet cable, a coaxial cable, and a microphone cable.

8. The navigation system of claim 7, wherein the power cable transmits power from a power source on the tugboat to the navigation detection assembly.

9. The navigation system of claim 7, wherein the coaxial cable and the microphone cable transmit real-time images of objects and real-time sound, respectively, from the navigation detection assembly to the navigation monitoring assembly.

10. The navigation system of claim 7, wherein the ethernet cable transmits signals from the navigation monitoring assembly to the navigation detection assembly for controlling the video camera.

11. A method for pushing a vessel away from an object using a tugboat, which comprises:
detecting the object ahead of the vessel using a navigation detection assembly detachably connected to a bow of the vessel;
transmitting real-time images of the object and real-time sound from the navigation detection assembly to the tugboat through an adjustable cable system; and
pushing the vessel using at least one of the real-time images of the object and the real-time sound to navigate the tugboat and the vessel away from the object.

12. The method of claim 11, wherein the tugboat and the vessel are navigated away from the object using only the tugboat and the at least one of the real-time images of the object and the real-time sound.

13. The method of claim 11, further comprising:
disconnecting the navigation detection assembly from the bow of the vessel;
connecting the navigation detection assembly to a bow of another vessel; and;
repeating the steps of claim 11 for pushing another vessel away from another object using the tugboat.

14. The method of claim 11, wherein the object is a shoreline, a pier or another vessel.

15. The method of claim 11, wherein the real-time images of the object include thermal images.

16. The method of claim 11, wherein the navigation detection assembly includes a laser range finder and a laser calibrator.

17. (canceled)

18. The method of claim 11, wherein the cable system includes a power cable, an ethernet cable, a coaxial cable, and a microphone cable.

19. The method of claim 18, further comprising adjusting the navigation detection assembly using the ethernet cable.

20. The method of claim 11, further comprising adjusting the cable system to detachably connect the navigation detection assembly to a bow of another vessel.
